(19) United States
(12) Patent Application Publication
(10) Pub. No.: US 2021/0155744 A1
(43) Pub. Date: May 27, 2021

(54) TWO-COMPONENT SYSTEM HAVING IMPROVED ADHESION

(71) Applicant: COVESTRO INTELLECTUAL PROPERTY GMBH & CO. KG, Leverkusen (DE)

(72) Inventor: Dirk HINZMANN, Pulheim (DE)

(21) Appl. No.: 17/045,480

(22) PCT Filed: Apr. 3, 2019
(86) PCT No.: PCT/EP2019/058352

§ 371 Date: Oct. 5, 2020

(30) Foreign Application Priority Data
Apr. 4, 2018 (EP) 18165622.4

(51) Int. Cl. C08G 18/62; C09D 175/16; C09D 133/06; C08G 18/40; C08G 18/61; C08G 18/32; C08J 7/043; C08J 7/04

(52) U.S. Cl. CPC C08G 18/6229; C09D 175/16; C09D 133/066; C08G 18/4063; C08G 18/61; C08G 18/6295; C08J 2433/14; C08J 7/043; C08J 7/0427; C09J 2483/00; C09J 2433/00; C08J 2369/00; C08J 2475/16; C08G 18/3203

(57) ABSTRACT

Described herein are two-component systems, a composite part comprising a coating made of the two-component system, a process for producing a composite part and a use of special siloxane-containing compounds. The addition of a polysiloxane-containing component, either chemically incorporated into the (meth)acrylate component or physically mixed into this component, results in an improved adhesion to a thermoplastic carrier.

The present invention relates to a two-component system, to a composite part comprising a coating made of the two-component system, to a process for producing a composite part and to a use of special siloxane-containing compounds.

Binders for modern lacquer systems must meet a multiplicity of requirements. As such they must exhibit certain lacquer performance properties such as scratch resistance, coverage and weather resistance while also ensuring good processability, economic production and compliance with legal requirements.

On account of the problem of VOCs, solvent- and elimination product-free polyurethane systems are of great interest since they may be cured largely without emission of volatile constituents after application. This also allows solvent-sensitive carriers to be coated. Solvent-free binder mixtures are in demand especially in thick-layer applications both for ecological reasons but also because complete emission of the solvent with simultaneous formation of a homogeneous, blister-free layer is not possible.

Solid coated mouldings may be produced by common knowledge processes such as RIM (Reaction Injection Moulding). A method particularly advantageous for producing the above-described thick layers (coatings with high layer thickness) is so-called In-Mould Coating (IMC). This comprises applying the coating components to the corresponding carrier in a mould and curing in the mould cavity. In addition to the abovementioned requirements the great advantages of IMC technology include rapid processing times, a low to negligible loss of raw materials and the production of a coated injection moulding (composite part) including the coating in one operation.

EP 0 943 637 A1 describes systems for use in RIM processes for example which result in transparent polyurethane coatings. Employed here is a polyol component based on polyether and/or polyester polyols having an average functionality >3 and an average hydroxyl number of 300 to 950 mg KOH/g. The choice of polyethers and/or polyesters as the polyol component in such applications is normally a consequence of their low viscosity. However, polyether polyols are less suitable in respect of lightfastness. Chemicals, solvent and weather resistance of polyester polyols is also in need of optimization depending on the application.

EP 1 484 350 A2 discloses solvent-free two-component systems for use in RIM or IMC processes. Here too, polyester polyols are used as the polyol component.

EP 0 693 512 A1 describes lightfast, abrasion-resistant and solvent-free polyurethane coatings of mixtures of HDI polyisocyanates with isocyanurate polyisocyanates based on cycloaliphatic diisocyanates. Employed here as polyol components are polyesters, polyethers, polycarbonates or polyestercarbonates and also castor oil and derivatives thereof.

EP 0 006 517 A1 describes polyols obtained by condensation of hydroxyl-functional polyacrylate resins with reactive polyesters and/or alkyd resins in the presence of alkoxy-containing polysiloxane. Incorporation of the polysiloxane is carried out to improve the weathering resistance of the resulting coating. It is described that dilution with customary solvents is necessary in order to establish the viscosities necessary for further processing. 50% solutions in xylene are produced in the examples.

EP 1 247 823 A2 likewise describes solvent-containing binders obtained by polymerization of a polyester component and an acrylate component. The polyester component is produced inter alia by incorporation of a methoxy-functional polysiloxane.

Similar solvent-containing systems (including aqueous systems in which water serves as the solvent) are described in U.S. Pat. Nos. 5,519,089 A, 5,346,958 A, 6,001,947 A, US2018/016381 A1, EP1494349 A2 and U.S. Pat. No. 5,710,201 A. All of these systems contain solvents and are thus suitable neither for the production of thick layers nor for use in RIM or IMC processes for the reasons recited above. In addition, the presence of the solvent causes some of these systems to exhibit other curing properties since for example monofunctional alcohols can act as chain terminators or the presence of water can bring about carbon dioxide formation and ultimately foaming. Likewise the solvent cannot escape in RIM or IMC processes since these employ closed injection moulds.

U.S. Pat. No. 5,519,089 A describes the addition of siloxanes having silylalkoxy groups. Such siloxanes are hydrolyzable and have crosslinking activity in the presence of moisture. None of the recited documents address improving the adhesion of the resulting systems to a carrier. However, it must also be noted that in some cases such solvent-containing systems as described above utilize the interaction of the solvent with the substrate for coating of carriers/substrates. For example a swelling of the substrate and thus also the alteration of the substrate can result in better adhesion. Here too it is apparent that such insights are not readily transferable to solvent-free systems. This applies in particular to applications in RIM or IMC processes where due to the freedom from solvent which is a consequence of the process adhesion must therefore be otherwise attained.

WO 2015/039837 A1 discloses binders based on a hydroxyl-functional acrylate resin, an alkoxy- and/or silanol-functional polysiloxane, one or more di- or polycarboxylic acids and one or more di- or polyols, all of which are condensed with one another in the binder. The chemical attachment of the polyols and the OH-functional polyacrylates is effected via the alkoxy or silanol groups of the polysiloxane to form an Si—O—C bond. This binder too is solvent-containing.

EP 0 550 259 A1 describes solvent-containing acrylate-based resins. An at least difunctional siloxane component is incorporated into the resin here. This siloxane component comprises at least one 3-acryloxypropyl group in order to be copolymerizable with vinyl monomers. This siloxane component necessarily further comprises at least one further functional group which is reactive toward isocyanate groups and thus optimizes the crosslinking properties of the resin.

The prior art thus discloses not only solvent-free systems based on polyether or polyester polyols but also solvent-containing systems based on acrylates.

When the solvent-free systems are used in an IMC process these systems form a coating on a carrier. It is particularly desirable for the adhesion between this coating and the carrier to be optimal. None of the recited documents investigate the adhesion of the resulting coatings to a carrier.

By contrast, WO 2015/055719 A1 and US2011/0159292 A1 describe optimization of the carrier employable in an IMC process in order to exhibit an improved adhesion to a general polyurethane lacquer.

The present invention accordingly has for its object to provide a two-component system which is usable for thick layer coatings and where at least one disadvantage of the prior art is improved. The present invention accordingly has for its object to provide a two-component system which is usable for thick layer coatings and simultaneously exhibits improved adhesion to a thermoplastic carrier, preferably polycarbonate. The term “thick layer coatings” is preferably to be understood as meaning that layers having a layer thickness of 1 to 1000 μm, particularly preferably 70 to 500 μm, very particularly preferably 90 to 400 μm, are obtainable without blister formation. The two-component systems shall in particular be suitable for use in an RIM and/or IMC process. The two-component systems shall moreover preferably be solvent-free.

At least one, preferably all of the abovementioned objects were achieved by the present invention. It has now been found that, surprisingly, a two-component system comprising a polyol component based on (meth)acrylates exhibits improved adhesion to a thermoplastic carrier, preferably polycarbonate, when the polyol component comprises exclusively primary hydroxyl groups while simultaneously at least one special polysiloxane component is present.

The present invention accordingly provides a two-component system comprising the components A) and B), wherein
A) is at least one (meth)acrylate component based on (meth)acrylate monomers which is produced by reaction of the (meth)acryloyl units of at least the components A1) and A2), wherein
   A1) is at least one alkyl ester of (meth)acrylic acid and
   A2) is at least one hydroxyalkyl ester of (meth)acrylic acid which comprises a primary hydroxyl group and wherein the alkylene group of the hydroxyalkyl ester is linear and comprises 2 to 6 carbon atoms,
      wherein the component A) comprises exclusively primary hydroxyl groups and has a hydroxyl number of 80 to 500 mg KOH/g and
B) is at least one polyisocyanate, wherein the component A) additionally comprises the component C), wherein
C) is at least one dihydric or polyhydric alcohol and/or at least one polyaspartic ester, characterized in that
(a) the component A) is produced by reaction of the (meth)acryloyl units of at least the components A1), A2) and A3), wherein
   A3) is at least one polysiloxane-containing (meth)acrylate
      and/or
(b) the component A) additionally comprises the component D), wherein
   D) is a polysiloxane which comprises at least one group reactive toward component B).

The invention comprises the embodiments (a) and (b) and also their combination with one another. In embodiment (a) at least one polysiloxane-containing component A3) is incorporated by the reaction of its (meth)acrylate group into the (meth)acrylate component A) based on (meth)acrylate monomers. In this variant the polysiloxane is thus present in component A) in chemically bonded form.

In embodiment (b) a polysiloxane D) comprising at least one polyisocyanate-reactive group is present in the form of a physical mixture with the component A). This means that the polysiloxane of the component D) is not chemically bonded to the (meth)acrylate component A). However, if the two-component system is cured the at least one group reactive toward the polyisocyanate of the component B) reacts with the polyisocyanate of the component B) and is thus chemically incorporated into the resulting coating by this reaction.

Unless otherwise explicitly stated the following applies to all inventive embodiments (a) and (b) and also their combination with one another. The invention provides a two-component system comprising the components A) and B). A kit of parts is preferably concerned here. This is to be understood as meaning that the components A) and B) are preferably a spatially separate arrangement to one another. When the components A) and B) are in contact with one another a reaction of these components takes place. This means that such a contacting of the components A) and B) is preferably carried out only shortly before use/curing.

The two-component system according to the invention comprises the components A) and B). It preferably consists of the components A) and B). It is provided that the components A) and B) may each also comprise further constituents which may differ in their chemical nature from those of the definition of the components A) and B). For example the component A) additionally contains the component C). The two-component system according to the invention is thus altogether composed of a component A) and a component B). It is especially preferable when the two-component system according to the invention is composed of 0.1% to 70% by weight of component B) and 99.9-30% by weight of the component A) based on the solid resin proportion of the component A). The recited weight fractions sum to 100% by weight. Those skilled in the art are familiar with how to select the amounts of the components A) and B) based on the equivalent weights of NCO and OH of the components.

It has now been found that, surprisingly, the two-component system according to the invention has an improved adhesion to thermoplastic carriers, in particular carriers comprising polycarbonate. It was found that neither the presence of exclusively primary hydroxyl groups in the component A) alone nor the presence of a polysiloxane component according to embodiment (a) (chemical incorporation into component A)) and/or embodiment (b) (physical incorporation into component A)) brings about such an improvement in adhesion. There is therefore a synergistic effect between the presence of exclusively primary hydroxyl groups and the presence of a special polysiloxane component. Without wishing to be bound to a particular theory it is thought that the exclusive presence of the primary hydroxyl groups results in a reactivity of the component A) toward B) which is optimized such that the polysiloxane groups have sufficient time to orient themselves for optimized adhesion in the setting coating while the coating also cures with good mechanical properties in an economic period of time.

The two-component system according to the invention is suitable for the production of thick layer coatings. This is particularly preferably to be understood as meaning that they are suitable for obtaining layers having a layer thickness of 1 to 1000 μm, particularly preferably 70 to 500 μm, very particularly preferably 90 to 400 μm. These thick layers are moreover preferably blister-free. The term “blister-free” is preferably to be understood as meaning that no transitions between two phases, preferably gas and the solid of the coating, are apparent to the naked eye inside the thick layer coating. The phase boundary between the thick layer coating and the ambient air is not included here since this transition is not “inside” the thick layer coating. The thick layer coatings preferably have a homogeneous surface.

The two-component system according to the invention is especially preferably suitable for use in an RIM and/or IMC process. This suitability is in particular associated with the structural requirements described above that the two-component system according to the invention is preferably substantially solvent-free and/or suitable for thick layer coatings. The two-component system according to the invention is preferably characterized in that the components A) and B) altogether contain not more than 3% by weight, particularly preferably not more than 1% by weight, of a solvent based on the total weight of the two-component system. It is very particularly preferable when the two-component system is solvent-free. Such solvents are preferably organic or aqueous solvents known to those skilled in the art or water which are substantially inert toward the components A) and B) but are employed to alter the viscosity of the components A) and/or B). It is particularly preferable when the two-component system according to the invention comprises not more than 3% by weight of solvent, preferably not more than 1% by weight of solvent and very particularly preferably no solvent selected from the group consisting of glycol ethers, such as ethylene glycol dimethyl ether, or glycol ether esters; esters, such as butyl acetate, butyl glycol acetate, 3-methoxy-n-butyl acetate, butyl diglycol acetate, methoxypropyl acetate, ethoxypropyl acetate, ethyl 3-ethoxypropionate, isobutyl acetate or amyl acetate; ketones, such as methyl n-amyl ketone, methyl ethyl ketone, methyl isobutyl ketone, diisobutyl ketone, cyclohexanone, isophorone; aromatic hydrocarbons, such as xylene; aliphatic hydrocarbons and water or aqueous systems which contain up to 60% by weight, preferably up to 75% by weight, particularly preferably up to 90% by weight, of water based on the total weight of the aqueous system. It is likewise preferable when the two-component system according to the invention comprises not more than 3% by weight of solvent, preferably not more than 1% by weight of solvent and very particularly preferably no solvent selected from the group consisting of monofunctional alcohols, such as n-propanol, isopropanol, n-butanol, tert-butylbutanol, isobutanol, pentanol, 2-methyl-1-butanol, isopentanol, neopentanol, hexanol, heptanol, octanol, allyl alcohol, benzyl alcohol, cyclohexanol, and ethers, such as dibutyl ether, ethylvinyl ether, methoxytoluene, diphenyl ether, dioxane, acetal, glycerol ether, tetrahydrofuran, 1,2-dimethoxyethane, methylcarbitol, 2-methoxyethanol, 2-ethoxyethanol, 2-butoxyethanol.

Component A)

According to the invention the component A) comprises at least one (meth)acrylate component based on (meth)acrylate monomers which is produced by reaction of the (meth)acryloyl units of at least the components A1) and A2), wherein
A1) is at least one alkyl ester of (meth)acrylic acid and
A2) is at least one hydroxyalkyl ester of (meth)acrylic acid which comprises a primary hydroxyl group and wherein the alkylene group of the hydroxyalkyl ester is linear and comprises 2 to 6 carbon atoms, wherein the component A) comprises exclusively primary hydroxyl groups and has a hydroxyl number of 80 to 500 mg KOH/g.

The term “(meth)acrylate component based on (meth)acrylate monomers” is preferably to be understood as meaning a polymeric component formed exclusively by the reaction of methacrylates and/or acrylates with one another. This preferably means that the component A) is obtained exclusively by the reaction of monomers comprising at least one (meth)acrylate group and that the polymer is constructed by the reaction of these (meth)acrylate groups with one another. It is preferable in particular when the polymer backbone of the component A) formed by the reaction of the (meth)acryloyl units comprises no ether and/or ester groups. This has the advantage in particular that the component A) in the resulting coating is lightfast, resistant to yellowing, chemicals-resistant, solvent-resistant and weather-resistant.

According to the invention the term specifying that the component A) comprises “exclusively primary hydroxyl groups” is preferably to be understood as meaning that the component A) may comprise a plurality of different components containing hydroxyl groups (for example via two different hydroxyalkyl esters of (meth)acrylic acid of the component A2)) but that in this case all components comprising hydroxyl groups comprise exclusively primary hydroxyl groups.

Inventive alkyl esters of (meth)acrylic acid A1) are in particular alkyl esters having 1 to 12 carbon atoms in the alkyl radical. These include for example methyl methacrylate, methyl acrylate, ethylhexyl acrylate, ethyl methacrylate, ethyl acrylate, isobornyl methacrylate, isobornyl acrylate, n-butyl acrylate, n-butyl methacrylate, isobutyl acrylate, isobutyl methacrylate, tert-butyl acrylate and tert-butyl methacrylate. Particularly preferred here are tert-butyl acrylate and ethyl acrylate.

Employable hydroxyalkyl esters of acrylic acid/methacrylic acid A1) include according to the invention hydroxyalkyl (meth)acrylate esters having 2 to 6 carbon atoms in the linear hydroxyalkyl radical, such as for example hydroxyethyl acrylate, hydroxyethyl methacrylate, hydroxypropyl methacrylate, hydroxypropyl acrylate, hydroxybutyl methacrylate, hydroxybutyl acrylate or mixtures thereof. Hydroxyethyl acrylate or hydroxybutyl acrylate are particularly preferred.

Those skilled in the art are capable of selecting/varying the individual (meth)acrylic esters and also optionally further constituents of the component A) such that the desired hardness and scratch resistance of the resulting coating are substantially attained. Those skilled in the art are aware that the more sterically demanding the alkyl radical in a (meth)acrylic ester the higher the glass transition temperature of the resulting coating. Those skilled in the art are likewise aware that methacrylates impart more hardness to a coating than acrylates. It is preferable when the components A1) and/or A2) are chosen such as to obtain a glass transition temperature of the cured coating of 0° C. to 80° C., particularly preferably 10° C. to 70° C. and very particularly preferably 25° C. to 60° C. The glass transition temperature is preferably determined as described in the examples.

It is further preferable when the component A) is produced by reaction of the (meth)acryloyl units of at least the components A1) and A2), wherein
A1) are at least two mutually distinct alkyl esters of (meth)acrylic acid and
A2) are at least two mutually distinct hydroxyalkyl esters of (meth)acrylic acid which each have a primary hydroxyl group and wherein the alkylene groups of the hydroxyalkyl esters are each linear and comprise 2 to 6 carbon atoms. The component A) thus preferably comprises at least four mutually distinct (meth)acrylic esters and optionally also the component A3).

It is thus further preferable when the component A2) comprises at least two mutually distinct hydroxyalkyl esters and the alkylene group of one hydroxyalkyl ester comprises 2 or 3 carbon atoms and the alkylene group of the at least one other hydroxyalkyl ester comprises 4 or 5 carbon atoms. It is very particularly preferable when the component A2) comprises a mixture of hydroxyethyl acrylate and hydroxybutyl acrylate. It is further preferable when the component A1) comprises a mixture of tert-butyl acrylate and ethyl acrylate. It is very particularly preferable when the component A1) consists of tert-butyl acrylate and ethyl acrylate and the component A2) consists of hydroxyethyl acrylate and hydroxybutyl acrylate.

It is preferable when the component A) comprises from 20% to 85% by weight, particularly preferably from 40% to 80% by weight, very particularly preferably from 60% to 75% by weight of the component A1) and from 80% to 15% by weight, particularly preferably from 60% to 20% by weight, very particularly preferably from 40% to 25% by weight of the component A2), wherein the % by weight values are based on the total weight of the components A1) and A2).

It is further preferable when in the embodiment (a) and the combination of the embodiment (a) with the embodiment (b) the component A) comprises 0.5% to 15% by weight, preferably 1% to 12% by weight of the component A3), wherein the % by weight values are based on the sum of the individual components having (meth)acryloyl units which form the component A).

It is likewise preferable when in the embodiment (b) and the combination of the embodiment (a) with the embodiment (b) the component A) comprises 0.25% to 10.00% by weight, preferably 0.3% to 5% by weight, very particularly preferably 0.4% to 2% by weight of the component D), wherein the % by weight values are based on the sum of the individual components having (meth)acryloyl units which form the component A). Depending on the chemical structure and the amount of the component D) demixing effects with the component A) may occur. However, these are avoidable for those skilled in the art for example by reducing the amount of the component A) within the abovementioned limits or increasing the phenyl substitutions of the component D) at the Si atom. Those skilled in the art are therefore capable of adapting the amount and structure of the component D) in particular within the recited preferences so that no demixing occurs and the effect according to the invention is achieved.

The component A) may further comprise at least one aromatic vinyl compound, for example styrene, alpha-methylstyrene or vinyltoluene and at least one (meth)acrylic acid. It is preferable when the component A) is obtained by reaction of the (meth)acryloyl units of at least the following components:
0% to 30% by weight of at least one aromatic vinyl compound, preferably styrene, alpha-methylstyrene or vinyltoluene
20% to 75% by weight of the component A1),
10% to 35% by weight of the component A2),
0% to 5% by weight of at least one (meth)acrylic acid and
0% to 10% by weight of the component A3),
in each case based on the total weight of the component A).

In the inventive embodiment (a) and the combination of the embodiment (a) with the embodiment (b) the two-component system according to the invention is further characterized in that the component A) is produced by reaction of the (meth)acryloyl units of at least the components A1), A2) and A3), wherein A3) is at least one polysiloxane-containing (meth)acrylate. This is preferably to be understood as meaning that the component A3) comprises at least one (meth)acrylate group and one polysiloxane segment. The component A3) is preferably monofunctional. This means that it comprises only one (meth)acrylate group. If the component A3) comprises more than one functionality the functional groups are preferably exclusively (meth)acrylate groups.

Compared to the prior art incorporation of the polysiloxane into a hydroxyl-containing component it is advantageous according to the invention when the polysiloxane A3) is incorporated into the component A) via the (meth)acrylate group(s). This affords an Si—C bond (and not an Si—O—C bond), thus rendering the component less susceptible to hydrolysis. The incorporation of the component A3) into the component A) thus forms a graft copolymer comprising a random poly(meth)acrylate backbone and polysiloxane chains.

It is preferable when the at least one polysiloxane-containing (meth)acrylate A3) conforms to formula (I)

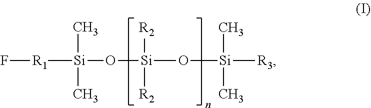

in which R₁ represents an alkylene group, preferably a linear or branched alkylene group having 1 to 18 carbon atoms, particularly preferably 2 to 6 carbon atoms,
R₂ each independently of one another represent an alkyl or aryl group, preferably a linear or branched alkyl group having 1 to 18 carbon atoms or an aryl group having 6 to 18 carbon atoms, particularly preferably a methyl group or a phenyl group,
R₃ represents an alkyl group, preferably a linear or branched alkylene group having 1 to 18 carbon atoms, particularly preferably 2 to 6 carbon atoms,
F represents an acryloxy or methacryloxy group and
n represents the average number of repeating units and is between 1 to 70, preferably between 5 to 65 and particularly preferably between 20 to 35.

The molecular weight Mn of the component A3) is thus preferably chosen such that it is between 500 and 5000 g/mol, preferably between 600 and 4000 g/mol and very particularly preferably between 700 and 3000 g/mol. The molecular weight is preferably determined by methods known to those skilled in the art.

Suitable components A3) are obtainable for example from Shin-Etsu Chemicals under the trade names KF-2012, X-22-174BX and X-22-174ASX.

In the inventive embodiment (b) and the combination of the embodiment (a) with the embodiment (b) the two-component system according to the invention is characterized in that the component A) additionally comprises the component D), wherein D) is a polysiloxane which has at least one group reactive toward component B). The component D) preferably comprises a polysiloxane which comprises at least one amino, mercapto, hydroxyl or hydroxypolyether group. The polysiloxane of the component D) particularly preferably conforms to formula (II)

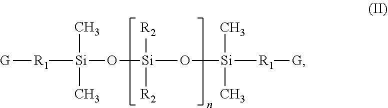

in which R₁ each independently of one another represent an alkylene group, preferably a linear or branched alkylene group having 1 to 18 carbon atoms, particularly preferably 2 to 6 carbon atoms,
R₂ each independently of one another represent an alkyl or aryl group, preferably a linear or branched alkyl group having 1 to 18 carbon atoms or an aryl group having 6 to 18 carbon atoms, particularly preferably a methyl group or a phenyl group,
G each independently of one another represent an amino, mercapto, hydroxyl or hydroxypolyether group, preferably an amino or hydroxyl group, and
n represents the average number of repeating units and is between 1 to 50, preferably between 5 to 40 and particularly preferably between 6 to 32.

The molecular weight Mn of the component D) is thus preferably chosen such that it is between 500 and 6000 g/mol, preferably between 600 and 5000 g/mol, very particularly preferably between 700 and 4500 g/mol. The molecular weight is preferably determined by methods known to those skilled in the art.

Suitable components A3) are obtainable for example from Shin-Etsu Chemicals under the trade names KF-6000, X-22-9409, X-22-1660B-3, X-22-4952, X-22-4272 and KF-6123 or from Evonik Industries AG under the trade name Tegomer H-Si 2315 or H-Si 6441P.

The production of the inventive component A) may be carried out according to the processes known to those skilled in the art as a solution or bulk polymerization, preferably as a solution polymerization. Solvents having boiling points from 80° C. to 220° C., preferably 100° C. to 185° C. may be used for the solution polymerization. Examples of such solvents are: glycol ethers, such as ethylene glycol dimethyl ether, glycol ether esters, ethyl such as butyl glycol acetate, 3-methoxy-n-butyl acetate, butyl diglycol acetate, methoxypropyl acetate, ethoxypropyl acetate, ethyl 3-ethoxypropionate, isobutyl acetate, amyl acetate; and ketones, such as methyl n-amyl ketone, methyl ethyl ketone, methyl isobutyl ketone, diisobutyl ketone, cyclohexanone, isophorone; aromatic hydrocarbons, such as xylene.

The polymerization may be performed continuously or discontinuously (in a so-called batch process). It is preferable when the polymerization is performed in a semi-batch process, i.e. the solvent and optionally monomers and/or reactive diluents such as for example polyhydric alcohols are initially charged in the reaction vessel while the further monomers and the initiator are added via one or more feeds over a period of 2 to 15 hours, preferably 3 to 8 hours.

Production of the inventive component A) may employ customary polymerization initiators individually or in admixture. These include aliphatic azo compounds, diacyl peroxides, peroxydicarbonates, alkyl peresters, alkyl hydroperoxides, perketals, dialkyl peroxide or ketone peroxides. The proportion of the initiators may be for example 0.1% to 8% by weight based on the total weight of the starting components. The polymerization is carried out at temperatures between 80° C. and 180° C., preferably at 80° C. to 140° C.

The polymerization process may be performed in either the presence or absence of a chain transfer agent. Employable chain transfer agents include typical species described for free-radical polymerization such as are known to those skilled in the art.

Sulfur-free molecular weight regulators include for example dimeric alpha-methylstyrene (2,4-diphenyl-4-methyl-1-pentene), enol ethers of aliphatic and/or cycloaliphatic aldehydes, terpenes, ß-terpines, terpinols, 1,4-cyclohexadiene, 1,4-dihydronaphthalene, 1,4,5,8-tetrahydronaphthalene, 2,5-dihydrofuran, 2,5-dimethylfuran and/or 3,6-dihydro-2H-pyran, alpha-methylstyrene being preferred.

Preferably employable as sulfur-containing molecular weight regulators are mercapto compounds, dialkyl sulfides, dialkyl disulfides and/or diaryl sulfides. Examples of polymerization regulators include: di-n-butyl sulfide, di-n-octyl sulfide, diphenyl sulfide, thiodiglycol, ethylthioethanol, diisopropyl sulfide, di-n-butyl disulfide, di-n-hexyl disulfide, diacetyl disulfide, diethanol sulfide, di-t-butyl trisulfide and dimethyl sulfoxide. Compounds preferably employed as molecular weight regulators are mercapto compounds, dialkyl sulfides, dialkyl disulfides and/or diaryl sulfides. Examples of these compounds are ethyl thioglycolate, 2-ethylhexyl thioglycolate, pentaerythritol tetrathioglycolate, cysteine, 2-mercaptoethanol, 1,3-mercaptopropanol, 3-mercaptopropane-1,2-diol, 1,4-mercaptobutanol, mercaptoacetic acid, 3-mercaptopropionic acid, thioglycolic acid, mercaptosuccinic acid, thioglycerol, thioacetic acid, thiourea and alkylmercaptans such as n-butylmercaptan, n-hexylmercaptan, t-dodecylmercaptan or n-dodecylmercaptan. In the context of the present invention the use of 2-mercaptoethanol and thioglycerol as chain transfer agents is very particularly preferred.

The molecular weight regulators are preferably employed in amounts of 0.05% to 10% by weight, in particular 1% to 6% by weight and particularly preferably 2-5.5% by weight based on the monomers employed in the polymerization.

The OH number (OHN) of the component A) according to the invention is in the range from 80 to 500 mg KOH/g, preferably in the range from 100 to 400 mg KOH/g, particularly preferably in the range from 120 to 350 mg KOH/g. Determination of the OH number is preferably carried out by titrimetry. This comprises acetylating the sample with acetic anhydride in the presence of pyridine. One mole of acetic acid is formed per hydroxyl group while the excess acetic anhydride provides two mol of acetic acid. The consumption of acetic acid is determined by titrimetry from the difference between the main value and a blank value to be performed simultaneously. The hydroxyl number is calculated taking account of the consumed ml of 0.5 n potassium hydroxide solution in the main and blank tests as well as the acid number (AN) of the sample and the starting weight.

$$OHN = \frac{( b - a ) \times 28.05}{E} + AN$$

a=consumed ml of 0.5 n potassium hydroxide solution in the main test
b=consumed ml of 0.5 n potassium hydroxide solution in the blank test
E=starting weight in g

The desired acid number (AN) for the binder according to the invention is in the range from 0.1 to 20 mg KOH/g, preferably in the range from 0.5 to 10 mg KOH/g, very particularly preferably 1 to 5 mg KOH/g. Determination of the acid number is likewise preferably carried out by titrimetry. The acid number indicates how many mg of KOH are required to neutralize the free fatty acids in 1 g of fatty acid. A suitable starting weight is weighed into a glass beaker, dissolved in about 100 mL of neutralized ethanol and titrated potentiometrically to the end point with sodium hydroxide solution. Acid number is evaluated as follows:

$$AN [ mgKOH / g ] = \frac{V \times 56.1 \times n \times f}{E}$$

V=titrant consumed (ml)
n=titrant normality
E=sample starting weight (g)
f=titrant factor

The molecular weights Mn of the component A) according to the invention are between 700 to 3000 g/mol, preferably 800 to 2000 g/mol. In the context of the present invention and unless otherwise stated molecular weights are determined by means of GPC measurements.

Determination of the weight-average molecular weight Mw, the number-average molecular weight Mn and the polydispersity Mw/Mn employed the following measurement conditions: column combination SDV 1000/10000 Å (length 65 cm), temperature 30° C., THF mobile phase, flow rate 1 ml/min, sample concentration 10 g/1, RI detector. Evaluation of the binders according to the invention was carried out against a polystyrene standard (162-2 570 000 g/mol).

Component B)

Component B) according to the invention is at least one polyisocyanate. Component B) preferably comprises at least two NCO groups. The employable polyisocyanates are polyisocyanates typically used in lacquers such as for example Desmodur® N products from Covestro Deutschland AG or the Vestanat® HT types from Evonik Industries AG.

Preferred polyisocyanates are the aromatic, araliphatic, aliphatic or cycloaliphatic polyisocyanates which have an NCO functionality of preferably 2 and are known per se to those skilled in the art and which may also comprise iminooxadiazinedione, isocyanurate, uretdione, urethane, allophanate, biuret, urea, oxadiazinetrione, oxazolidinone, acylurea and/or carbodiimide structures. These may be employed individually or in any desired mixtures with one another.

The abovementioned polyisocyanates are based on di- and/or triisocyanates known per se to the skilled person and having aliphatically, cycloaliphatically, araliphatically and/or aromatically bonded isocyanate groups, it being immaterial whether they were produced using phosgene or by phosgene-free processes. Examples of such di- or triisocyanates are 1,4-diisocyanatobutane, 1,5-diisocyanatopentane, 1,6-diisocyanatohexane (HDI), 2-methyl-1,5-diisocyanatopentane, 1,5-diisocyanato-2,2-dimethylpentane, 2,2,4- and 2,4,4-trimethyl-1,6-diisocyanatohexane, 1,10-diisocyanatodecane, 1,3- and 1,4-diisocyanatocyclohexane, 1,3- and 1,4-bis(isocyanatomethyl)cyclohexane, 1-isocyanato-3,3,5-trimethyl-5-isocyanatomethylcyclohexane (isophorone diisocyanate, IPDI), 4,4′-diisocyanatodicyclohexylmethane (Desmodur® W, Bayer AG, Leverkusen, DE), 4-isocyanatomethyl-1,8-octane diisocyanate (triisocyanatononane, TIN), ω, ω′-diisocyanato-1,3-dimethylcyclohexane (H6XDI), 1-isocyanato-1-methyl-3-isocyanatomethylcyclohexane, 1-isocyanato-1-methyl-4-isocyanatomethylcyclohexane, bis(isocyanatomethyl)norbornane, 1,5-naphthalene diisocyanate, 1,3- and 1,4-bis(2-isocyanatoprop-2-yl)benzene (TMXDI), 2,4- and 2,6-diisocyanatotoluene (TDI), in particular the 2,4 and the 2,6 isomers, and technical mixtures of the two isomers, 2,4′- and 4,4′-diisocyanatodiphenylmethane (MDI), polymeric MDI (pMDI), 1,5-diisocyanatonaphthalene, 1,3-bis(isocyanatomethyl)benzene (XDI) and any desired mixtures of the recited compounds.

It is preferable when the polyisocyanates have an average NCO functionality of 2.0 to 5.0, preferably of 2.2 to 4.5, particularly preferably of 2.2 to 2.7, and a content of isocyanate groups of 5.0% to 37.0% by weight, preferably of 14.0% to 34.0% by weight.

In a preferred embodiment polyisocyanates or polyisocyanate mixtures of the abovementioned type having exclusively aliphatically and/or cycloaliphatically bonded isocyanate groups are employed.

It is very particularly preferred when the polyisocyanates of the abovementioned type are based on hexamethylene diisocyanate, isophorone diisocyanate, the isomeric bis(4,4′-isocyanatocyclohexyl)methanes and mixtures thereof.

The proportion of polyisocyanate of the component B) is preferably chosen such that there are 0.5 to 1.5, preferably 0.9 to 1.1 and particularly preferably 1.0 isocyanate groups per hydroxyl group of the component A) according to the invention.

Component C)

The two-component system according to the invention always further comprises at least in one of the components A) and B) a component C) which is at least one di- or higher-functional alcohol and/or at least one polyaspartic ester. The component C) is thus a constituent of at least the component A) and/or component B).

The component C) is also referred to as a reactive diluent and is used for adjusting the viscosity of the component A). It is preferable when the di- or higher-functional alcohol is selected from the group consisting of ethanediol, diethylene glycol, 1,2- and 1,3-propanediol, 2-methyl-1,3-propanediol, dipropylene glycol, 1,4-butanediol, 1,3-butanediol, 1,5-pentanediol, 1,6-hexanediol, 1,10-decanediol, 1,12-dodecanediol, glycerol, trimethylolpropane and 8(9)-dihydroxymethyltricyclo[5.2.1.02.6]decane (TCD-alcohol DM). It is preferable when ethanediol, diethylene glycol, 1,2- or 1,3-propanediol, 2-methyl-1,3-propanediol, 1,4-butanediol or 1,3-butanediol are employed. Also employable as the reactive diluent component are polyaspartic esters. Suitable polyaspartic esters are obtainable for example from Covestro Deutschland AG under the trade names Desmophen NH 1220, Desmophen NH 1420, Desmophen NH 1520 and Desmophen NH 2850 XP. Polyaspartic esters may preferably be described by general formula (III), wherein X is an alkylene or cycloalkylene group.

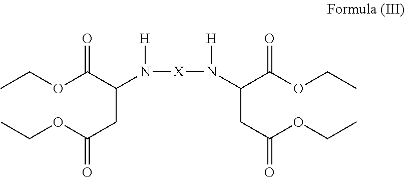

In a preferred embodiment the component C) comprises no polyaspartic esters.

According to the invention the term “alcohol” preferably also encompasses linear or branched alcohols containing ester groups and/or ether groups. In this case the alcohol may also be oligomeric. Examples of such components are Capa 2043, Capa 3031, W′ Pol 1181/03 or 1181/09. In this case the component A) is present in a quantitative excess with respect to the oligomeric alcohol of the component C). As described hereinabove component C) is used as a reactive diluent for adjusting the viscosity of the component A). Corresponding disadvantageous properties which the two-component system according to the invention could exhibit due to the presence of ether or ester groups are thus negligible on account of the small amounts of these groups.

The component D) has been more particularly described hereinabove under component A).

The two-component system according to the invention is preferably characterized in that the at least one of the components A) and B) additionally comprises at least one assistant or additive substance. These are preferably selected from the group consisting of catalysts, reaction retarders, pigments, dyes, flame retardants, stabilizers, plasticizers, fungistatic or bacteriostatic substances, fillers and additives typically used in lacquers.

The catalysts are for example tertiary amines (such as triethylamine, tributylamine, N-methylmorpholine, N-ethylmorpholine, N,N,N′,N′-tetramethylethylenediamine, pentamethyldiethylenetriamine and higher homologues, 1,4-diazabicyclo(2,2,2)octane, N-methyl-N′-dimethylaminoethylpiperazine, bis(dimethylaminoalkyl)piperazines, N,N-dimethylbenzylamine, N,N-dimethylcyclohexylamine, N,N-diethylbenzylamine, bis(N,N-diethylaminoethyl) adipate, N,N,N′,N′-tetramethyl-1,3-butanediamine, N,N-dimethyl-β-phenylethylamine, 1,2-dimethylimidazole, 2-methylimidazole, monocyclic and bicyclic amides, bis(dialkylamino) alkyl ethers, amide groups (preferably formamide groups) comprising tertiary amines, Mannich bases of secondary amines (such as dimethylamine) and aldehydes, (preferably formaldehyde or ketones such as acetone, methyl ethyl ketone or cyclohexanone) and phenols (such as phenol, nonylphenol or bisphenol), tertiary amines comprising isocyanate-active hydrogen atoms (e.g. triethanolamine, triisopropanolamine, N-methyldiethanolamine, N-ethyldiethanolamine, N,N-dimethylethanolamine) and the reaction products thereof with alkylene oxides such as propylene oxide and/or ethylene oxide, secondary/tertiary amines, silanamines having carbon-silicon bonds (2,2,4-trimethyl-2-silamorpholine and 1,3-diethylaminomethyltetramethyldisiloxane), nitrogen-containing bases (such as tetraalkylammonium hydroxides), alkali metal hydroxides (such as sodium hydroxide, alkali metal phenoxides such as sodium phenoxide), alkali metal alkoxides (such as sodium methoxide) and/or hexahydrotriazines.

The reaction between NCO groups and Zerewitinoff-active hydrogen atoms is also greatly accelerated in a manner known per se by lactams and azalactams by initially forming an adduct between the lactam and the compound comprising acidic hydrogen.

Also employable as catalysts are organic metal compounds, in particular organic tin and/or bismuth compounds. Preferably contemplated as organic tin compounds in addition to sulfur-containing compounds such as di-n-octyl tin mercaptide are tin(II) salts of carboxylic acids such as tin(II) acetate, tin(II) octoate, tin(II) ethylhexoate and tin(II) laurate and the tin(IV) compounds, for example dibutyltin oxide, dibutyltin dichloride, dibutyltin diacetate, dibutyltin dilaurate, dibutyltin maleate or dioctyltin diacetate. Organic bismuth catalysts are described in patent application WO 2004/000905 for example.

It will be appreciated that all of the abovementioned catalysts may be employed as mixtures. Combinations of organic metal compounds and amidines, aminopyridines or hydrazinopyridines are of particular interest.

The catalysts are generally used in an amount of about 0.001% to 10% by weight based on the total amount of compounds having at least two isocyanate-reactive hydrogen atoms (at least component A) and C)).

Suitable reaction retarders are for example acidic substances (such as hydrochloric acid or organic acid halides).

Contemplated additives/components typically used in lacquers include for example pigments or dyes and flame retardants of the type known per se (for example trischloroethyl phosphate, tricresyl phosphate or ammonium phosphate and polyphosphate) and also stabilizers against ageing and weathering effects, plasticizers and fungistatic and bacteriostatic substances, fillers (such as barium sulfate, diatomaceous earth, carbon black or precipitated chalk), defoamers, deaerators, slippants and glidants, dispersants, anti-scratch additives; UV stabilizers (UV absorbers, HALS) and substrate wetting agents (for example Tego Wet 260).

A further aspect of the present invention comprises providing a composite part comprising a carrier and at least one coating in direct contact with the substrate/the carrier, wherein the substrate/the carrier comprises a thermoplastic composition and the coating is obtained by curing the two-component system according to the invention. Those skilled in the art are aware of how to bring about curing of the two-component system according to the invention. It is preferable when the coating is produced by polymerization of the two-component system according to the invention in direct contact with the carrier previously moulded from the thermoplastic composition and solidified.

The thermoplastic composition of the substrate/carrier preferably comprises at least one polycarbonate or polymethyl methacrylate, particularly preferably polycarbonate. This is more preferably an aromatic (co)polycarbonate. It is very particularly preferable when the (co)polycarbonate is based on bisphenol A and optionally a further bisphenol distinct from bisphenol A. According to the invention the terms “substrate” and “carrier” are preferably used synonymously and are therefore interchangeable.

The composite parts may in principle be produced in any known manner.

In the preferred embodiment of the invention the application of the coating of the two-component system according to the invention and optionally the curing is carried out by the process of reaction injection moulding in closed moulds. Likewise preferred in this context is dispensing with a closed mould in the recited technique, the ready-to-use coating composition then being applied straight onto suitable carriers and optionally cured by heating. These cured coatings may optionally be subjected to subsequent aftertreatment by mechanical processes such as polishing for example.

The composite part may be preprepared from the thermoplastic composition for example, the two-component system according to the invention being applied thereto and end-cured. Depending on the reactivity of the two-component system the components A) and B) may already have been premixed or may be mixed in a known manner during application. Application may be carried out inter alia by spraying, knife coating or calendaring. However, it is also possible to produce the composite parts according to the invention by coextrusion by known methods.

A further aspect of the present invention provides a process for producing a composite part, wherein the composite part comprises a carrier and at least one coating, comprising the steps of:
(i) providing a carrier, wherein the carrier comprises a thermoplastic composition,
(ii) applying at least the two-component system according to the invention, wherein the two-component system is in direct contact with the carrier, and
(iii) curing the two-component system to afford a coating.

The preferences for the thermoplastic carrier have already been described hereinabove.

It is moreover preferable when this process comprises the process steps (i2) to (iv2) in which (i2) in a first process step the melt of a thermoplastic composition is injected into a first mould cavity and subsequently cooled to afford a carrier,
(ii2) in a second process step the cavity of the injection moulding tool is enlarged to produce a gap,
(iii2) in a third process step the two-component system according to the invention is injected into the thus produced gap of step (ii2) between the carrier of the process step (i2) and the mould surface of the enlarged cavity, wherein the two-component system is cured in direct contact with the surface of the carrier to form a composite part and
(iv2) in the fourth process step the composite part of step (iii2) is demoulded from the mould cavity,
wherein the process steps (i2) to (iv2) follow one another in immediate succession.

The immediate succession of the process steps prevents the temperature of the workpiece cooling to room temperature during the process. This achieves a reduction in production times and a higher energy efficiency of the overall process.

The process steps (ii2) and (iii2) may be repeated at least once while varying the two-component system to apply one or more coatings onto only one or both sides of the carrier to afford a composite part made of a thermoplastic carrier and at least two identical or different polyurethane components optionally having a more than bilayered construction.

Before demoulding of the workpiece in the steps (ii2) and (iv2) the workpiece is cooled until dimensional stability is achieved.

To produce the gap in process step (ii2) it is possible either to open the injection mould and subsequently replace one half of the injection mould cavity with a new half having larger hollow mould dimensions or to move the part from the first mould cavity into a second cavity, larger in terms of its hollow mould dimensions, of the same mould or of a second mould, or to open the first cavity by one gap dimension.

The movement of the carrier in the process step (ii2) may be carried out by known methods such as are used for example in multicolour injection moulding. Typical processes are movement with a turntable, a turning plate, a sliding cavity or an index plate, or comparable methods in which the carrier remains on a core. If the carrier to be moved remains on the core, this has the advantage that the position is defined accurately even after the displacement. On the other hand, the prior art discloses methods for moving a carrier in which the carrier is removed from a cavity, for example with the aid of a handling system, and placed into another cavity. Movement with removal of the carrier offers greater freedom of configuration in the coating operation, for example in the generation of an edge fold or masked regions.

It is preferable when the surface of the injection mould contacting the two-component system in process step (iii2) is heated to a temperature in the range from 50° C. to 160° C., preferably 70° C. to 120° C., more preferably 80° C. to 110° C. and particularly preferably 90° C. to 100° C.

The composite parts according to the invention are particularly suitable as an interior or exterior component of a rail, aerospace or motor vehicle, for electricals/electronics components and IT components. Such composite parts are particularly suitable for fitout parts in vehicle manufacture such as for example dashboards, displays, door or other trim, steering wheels or the like. In a further aspect the present invention therefore also relates to the use of the composite part according to the invention/the composite part obtained by the process according to the invention as an interior or exterior component of a rail, aerospace or motor vehicle, for electricals/electronics components and IT components, preferably for fitout parts in vehicle manufacture such as for example dashboards, displays, door or other trim, steering wheels or the like.

A further aspect of the present invention is the use of at least one polysiloxane-containing (meth)acrylate as comonomer A3) in a (meth)acrylate component A) based on (meth)acrylate monomers which is a component of a two-component system which comprises
A) at least the (meth)acrylate component based on (meth)acrylate monomers produced by reaction of the (meth)acryloyl units of at least the components A1), A2) and A3), wherein
A1) is at least one alkyl ester of (meth)acrylic acid,
A2) is at least one hydroxyalkyl ester of (meth)acrylic acid which comprises a primary hydroxyl group and wherein the alkylene group of the hydroxyalkyl ester is linear and comprises 2 to 6 carbon atoms and
A3) is at least one polysiloxane-containing (meth)acrylate, wherein the component A) comprises exclusively primary hydroxyl groups and has a hydroxyl number of 80 to 500 mg KOH/g and
B) comprises at least one polyisocyanate,
wherein the component A) additionally comprises the component C), wherein
C) is at least one di- or higher-functional alcohol and/or at least one polyaspartic ester, for improving the adhesion properties of the two-component system.

The present invention likewise relates to the use of a polysiloxane which comprises at least one group reactive toward polyisocyanate components in a two-component system comprising
A) at least one (meth)acrylate component based on (meth)acrylate monomers produced by reaction of the (meth)acryloyl units of at least the components A1), A2) and optionally A3), wherein
A1) is at least one alkyl ester of (meth)acrylic acid,
A2) is at least one hydroxyalkyl ester of (meth)acrylic acid which comprises a primary hydroxyl group and wherein the alkylene group of the hydroxyalkyl ester is linear and comprises 2 to 6 carbon atoms and
A3) is optionally at least one polysiloxane-containing (meth)acrylate, wherein the component A) comprises exclusively primary hydroxyl groups and has a hydroxyl number of 80 to 500 mg KOH/g and
B) at least one polyisocyanate,
wherein the component A) additionally comprises the component C), wherein
C) is at least one dihydric or polyhydric alcohol and/or at least one polyaspartic ester, for improving the adhesion properties of the two-component system.

In the abovementioned uses it is preferable when the adhesion properties of the two-component system with respect to a carrier comprising at least one polycarbonate are improved. In these inventive uses it is preferable to employ the components more particularly and preferably described hereinabove.

### EXAMPLES

In the context of the present invention, the following methods have been used in addition to those measurement methods for determining OH groups and for determining acid number already stated above:

a) Viscosity, Determined Using Brookfield LV-DV-I+ Spindle Viscometer

Viscosities were determined by means of a Brookfield LV-DV-I+ spindle viscometer. Brookfield viscometers are rotary viscometers having defined spindle sets as rotary bodies. The rotary bodies used were from an LV spindle set. Owing to the temperature dependence of viscosity, the temperatures of the viscometer and of the measuring liquid were kept constant during the measurement, with an accuracy of +/−0.5° C. Materials used in addition to the LV spindle set were a thermostatable waterbath, a 0-100° C. thermometer (scale divisions 1° C. or smaller) and a timer (scale values not greater than 0.1 second). To perform the measurement, 100 ml of the sample were introduced into a wide-necked bottle and measured under temperature-controlled conditions in the absence of air bubbles after prior calibration. To determine viscosity the viscometer was positioned relative to the sample such that the spindle dips into the product up to the mark. Measurement is initiated using the start button and care was taken to ensure that the measurement took place in the favourable measurement region of 50% (+/−20%) of the maximum measurable torque. The result of the measurement was displayed by the viscometer in mPas and division by the density (g/ml) gives the viscosity in mm2/s.

b) Pendulum hardness according to König

For the pendulum hardness determination according to Konig (DIN 53157 or EN ISO 1522 April 2007 edition) the measure used is the damping of a swinging pendulum. The pendulum with two stainless steel balls is placed onto a coating film. There is a physical relationship between duration of pendulum swinging, amplitude, and the geometric dimensions of the pendulum. The viscoelastic behaviour of the coating is determinative for hardness. When the pendulum is set in swinging motion the balls roll on the surface and thus exert pressure on it. The greater or lesser recovery is dependent on elasticity. The absence of elastic forces causes severe damping of the pendulum movement. By contrast, high elastic forces cause only slight damping. Pendulum hardness according to “Konig”: number of swings in osc. 1 oscillation=1.4 seconds.

c) Crosshatch Testing

Adhesion was tested by means of crosshatch testing according to the standard DIN EN ISO 2409 (August 2007 edition).

d) Crockmeter Scratch Resistance

Scratch resistance was tested by means of a crockmeter according to the standard DIN 55654 (August 2015 edition).

e) Clouding Measurement

Haze measured according to the standard ASTM 1003 (2011 version) Ahaze is determined according to the following formula:

Δhaze=haze (crockmeter value)−haze (starting value)

e) Hydrolytic Ageing

The coated sample is subjected to hydrolytic ageing at 90±2° C. and 95±1% relative humidity for 72 hours in a climate test cabinet. The adhesion of the coated sample is tested by crosshatch testing (according to the standard DIN EN ISO 2409, August 2007 edition).

f) Glass Transition Temperature (Tg)

The glass transition temperature of the crosslinked polymer film consisting of the polyol component and the polyisocyanate curing agent is measured according to DIN EN ISO11357-1 (1997 edition). The measurement range was −50° C. to 150° C. at a heating rate of 10K/min.

### Examples 1 to 5 and Comparative Example 6 (Embodiment (a))

In a polymerization vessel fitted with a dropping funnel, stirrer and cooler the process solvent methyl isobutyl ketone was initially charged and the raw materials were employed in the ratios as reported in table 1. The mercapto-functional regulator and the (meth)acrylate monomers and the initiator were uniformly added at the same temperatures over the course of three hours. Once addition was complete polymerization was carried out for a further 2 hours at the same temperature. The process solvent was then removed by distillation and the (meth)acrylate component was admixed with 1,3-butanediol.

TABLE 1

| | | | | | | Comparative |
|---|---|---|---|---|---|---|
| Raw material | Example 1 | Example 2 | Example 3 | Example 4 | Example 5 | example 6 |
| tetrabutyl acrylate | 20 | 20 | 20 | 20 | 20 | 20 |
| hydroxyethyl | 12 | 12 | 12 | 12 | 12 | 12 |
| acrylate | | | | | | |
| 4-hydroxybutyl | 15 | 15 | 15 | 15 | 15 | |
| acrylate | | | | | | |
| 2-hydroxypropyl | | | | | | 13.5 |
| acrylate | | | | | | |
| ethyl acrylate | 48 | 43 | 48 | 43 | 51.5 | 53 |
| A3)-1)* | 5 | 10 | | | | |
| A3)-2)** | | | 5 | 10 | 1.5 | 1.5 |
| 1,3-butanediol | 11 | 11 | 11 | 11 | 18 | 18 |
| viscosity (mPa*s) | 21 670 | 22 483 | 13 360 | 21 835 | 21 442 | 25 695 |
| OH number | | | | | | |
| (mg KOH/g) | 258 | 250 | 245 | 244 | 309 | 269 |
| AN (mg KOH/g) | 7.5 | 0.8 | 0.7 | 0.8 | 1.1 | 1.1 |

*component A3)-1) represents a methacryloyl-functional polysiloxane of formula (I) where R₁ = C₃H₆, R₂ = CH₃, R₃ = CH₃, F = —O—(C═O)—C(CH₃)═CH₂ and n = 8-9
**component A3)-2) represents a methacryloyl-functional polysiloxane of formula (I) where R₁ = C₃H_{6,} R₂ = CH₃, R₃ = CH₃, F = —O—(C═O)—C(CH₃)═CH₂ and n = 27-30

### Examples 7, 8 and 13 and Comparative Examples 9 to 12 (Embodiment (b))

In a polymerization vessel fitted with a dropping funnel, stirrer and cooler the process solvent methyl isobutyl ketone was initially charged and the raw materials were employed in the ratios as reported in table 2. The mercapto-functional regulator and the (meth)acrylate monomers and the initiator were uniformly added at the same temperatures over the course of three hours. Once addition was complete polymerization was carried out for a further 2 hours at the same temperature. The process solvent was subsequently removed by distillation and the binder admixed with the respective functionalized polydimethylsiloxane D) and 1,3-butanediol.

TABLE 2

| | Example | Example | Comparative | Comparative | Comparative | Comparative | Example |
|---|---|---|---|---|---|---|---|
| Raw material | 7 | 8 | example 9 | example 10 | example 11 | example 12 | 13 |
| tetrabutyl | 20 | 20 | 20 | 20 | 20 | 20 | 20 |
| acrylate | | | | | | | |
| hydroxyethyl | 12 | 12 | | | 12 | 12 | 12 |
| acrylate | | | | | | | |
| 4-hydroxybutyl | 15 | 15 | 15 | 15 | | | 15 |
| acrylate | | | | | | | |
| 2-hydroxy-propyl | | | 13.5 | 13.5 | 13.5 | 13.5 | |
| acrylate | | | | | | | |
| ethyl acrylate | 53 | 53 | 51.5 | 51.5 | 54.5 | 54.5 | 53 |
| D)-1)* | 0.5 | 1.0 | 0.5 | 1.0 | 0.5 | 1.0 | |
| D)-2)** | | | | | | | 1.5 |
| 1,3-butanediol | 11 | 11 | 18 | 18 | 18 | 18 | 11 |
| viscosity | 20 847 | 20 500 | 19 400 | 20 300 | 27 644 | 19 400 | 20 600 |
| (mPa*s) | | | | | | | |
| OH number | 245 | 245 | 301 | 302 | 301 | 301 | 245 |
| (mg KOH/g) | | | | | | | |
| AN (mg KOH/g) | 0.9 | 1.0 | 0.8 | 0.9 | 0.5 | 0.8 | 1.0 |

*component D)-1) represents an alpha-omega-organomodified difunctional siloxane of formula (II) where R₁ = C₃H₆, R₂ = CH₃, and G = —OC₂H₄OH where n = 8-0.
**component D)-2) represents an alpha-omega-organomodified difunctional siloxane of formula (II) where R₁ = C₃H₆, R₂ = CH₃ G = C₆H₁₃N and n = 30.

### Comparative Example 14

In a polymerization vessel fitted with a dropping funnel, stirrer and cooler the process solvent methyl isobutyl ketone was initially charged and from a first dropping funnel the monomers 20 g of tetrabutyl acrylate, 12 g of hydroxyethyl acrylate, 15 g of 4-hydroxybutyl acrylate, 53 g of ethyl acrylate and the initiator, and from a second dropping funnel the mercapto-functional regulator, were added uniformly at the same temperature over three hours. Once addition was complete polymerization was carried out for a further 2 hours at the same temperature. The process solvent was then removed by distillation and the binder was admixed with 11 g of 1,3-butanediol.

Viscosity: 20 845 mPa*s

OH number: 244 mgKOH/g

Acid number: 0.9 mgKOH/g

### Production of a Coating Example 15

From the corresponding components A) from the examples and comparative examples 1 and 14 a clear lacquer was produced as follows (table 3). Employed as comparison 1 is a branched polyester polyol based on the polyester building blocks isophthalic acid and adipic acid reacted with di- and trifunctional alcohols for in-mould coatings and the non-siloxane-modified comparative binder from example 14.

TABLE 3

| Raw | | | | | | | | | | | | | | | |
|---|---|---|---|---|---|---|---|---|---|---|---|---|---|---|---|
| material | CE15-1 | 15-2 | 15-3 | 15-4 | 15-5 | 15-6 | CE15-7 | 15-8 | 15-9 | CE15-10 | CE15-11 | CE15-12 | CE15-13 | CE15-14 | 15-15 |
| Comparison | 99 | | | | | | | | | | | | | | |
| 1 | | | | | | | | | | | | | | | |
| Comparative | | | | | | | | | | | | | | 99 | |
| example 14 | | | | | | | | | | | | | | | |
| Ex. 1 | | 99 | | | | | | | | | | | | | |
| Ex. 2 | | | 99 | | | | | | | | | | | | |
| Ex. 3 | | | | 99 | | | | | | | | | | | |
| Ex. 4 | | | | | 99 | | | | | | | | | | |
| Ex. 5 | | | | | | 99 | | | | | | | | | |
| Comparative | | | | | | | 99 | | | | | | | | |
| ex. 6 | | | | | | | | | | | | | | | |
| Ex. 7 | | | | | | | | 99 | | | | | | | |
| Ex. 8 | | | | | | | | | 99 | | | | | | |
| Comparative | | | | | | | | | | 99 | | | | | |
| ex. 9 | | | | | | | | | | | | | | | |
| Comparative | | | | | | | | | | | 99 | | | | |
| ex. 10 | | | | | | | | | | | | | | | |
| Comparative | | | | | | | | | | | | 99 | | | |
| ex. 11 | | | | | | | | | | | | | | | |
| Comparative | | | | | | | | | | | | | 99 | | |
| ex. 12 | | | | | | | | | | | | | | | |
| Ex. 13 | | | | | | | | | | | | | | | 99 |
| Tib kat 218 | 0.02 | 0.02 | 0.02 | 0.02 | 0.02 | 0.02 | 0.02 | 0.02 | 0.02 | 0.02 | 0.02 | 0.02 | 0.02 | 0.02 | 0.02 |
| (1) | | | | | | | | | | | | | | | |
| Tego Wet | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 |
| 260 (2) | | | | | | | | | | | | | | | |
| B) (3) | 174 | 80 | 80 | 80 | 80 | 100.5 | 100.5 | 79.2 | 79 | 97.6 | 97.3 | 97.6 | 97.6 | 79 | 79 |

(1) Tego Wet 260 is a substrate wetting additive from Evonik Industries AG (polyether siloxane copolymer)

(2) Tib Kat 218 is a catalyst from Tib Chemicals (dibutyltin dilaurate)

(3) Component B): aliphatic HDI trimer

The coatings from example 15 were applied to a 3.2 mm polycarbonate sheet (bisphenol A polycarbonate) having a visual transparency T_{VIS} of 88% and an MVR of about 19 cm³/(10 min) measured at 300° C. and 1.2 kg loading (according to ISO 1133-1:2012-03) from Covestro Deutschland AG with a blade coater in a dry layer thickness of about 120 μm. The lacquer was then cured at 120° C. for 60 minutes in a recirculating drying oven.

Pendulum hardnesses according to Konig, scratch resistance by crockmeter and adhesion after hydrolytic ageing were then evaluated. The results are summarized in table 4.

TABLE 4

| | | Glass | | |
|---|---|---|---|---|
| | Pendulum | transition | Crockmeter | |
| | hardness | temperature | 2000 | |
| | according | of cured | strokes, | |
| | to Ko\ddot{n}ig | lacquer film | 22.5N | Adhesion after |
| Coating | in sec. | in ° C. | ΔHaze | hydrolytic ageing |
| CE15-1 | 124 | 58-60 | 0.1 | GT 5 (complete |
| | | | | detachment of the |
| | | | | lacquer film from |
| | | | | the substrate) |
| 15-2 | 79 | | 0 | GT 2 |
| 15-3 | 69 | | 0 | GT 0 |
| 15-4 | 94 | | 0 | GT 0 |
| 15-5 | 48 | 36-40 | 0 | GT 0 |
| 15-6 | 81 | | 0.53 | GT 3 |
| CE15-7 | 69 | 28-30 | 0.1 | GT 5 (complete |
| | | | | detachment of the |
| | | | | lacquer film from |
| | | | | the substrate) |
| 15-8 | 106 | 30-31 | 0 | GT 0 |
| 15-9 | 76 | | 0.2 | GT 1 |
| CE15-10 | 114 | | 1.8 | GT 5 (complete |
| | | | | detachment of the |
| | | | | lacquer film from |
| | | | | the substrate) |
| CE15-11 | 115 | | 0.2 | GT 4 |
| CE15-12 | 85 | | 0.2 | GT 4 |
| CE15-13 | 87 | | 0.5 | GT 5 |
| CE15-14 | 80 | 18-22 | 44 | GT 5 (complete |
| | | | | detachment of the |
| | | | | lacquer film from |
| | | | | the substrate) |
| 15-15 | 68 | | 0.5 | GT 0 |

As is apparent from the results of the table the addition of a siloxane component alone (CE15-7) or else the presence of primary hydroxyl groups in component A) alone (CE15-14) does not result in sufficient adhesion to the carrier. Only the combination of the addition of a siloxane component and the exclusive presence of primary hydroxyl groups in component A) results in good adhesion properties (15-2 to 15-6 and 15-8, 15-9 and 15-15).

Resistance against hand cream and sun cream and also against acetone and butyl acetate as solvents was also tested as reported in table 5.

For cream resistance a gauze bandage imbued with hand cream and sun cream was in each case placed on the surface of the coating followed by subjection to 80° C. in the recirculating oven for 24 hours. The damage to the lacquer surface was then visually assessed.

For solvent resistance an impregnated cotton pad was placed on the surface of the coating and damage to the lacquer surface was visually assessed after 1, 5, 15, 30 and 60 minutes.

TABLE 5

| | | | Acetone | Butyl acetate |
|---|---|---|---|---|
| | Hand cream | Sun cream | 1, 5, 15, 30, 60 | 1, 5, 15, 30, 60 |
| Coating | 24 h 80° C. | 24 h 80° C. | min | min |
| CE15-1 | 1 | 2 | 1/2/2/2/2 | 1/1/1/2/2 |
| 15-2 | 1 | 2 | 1/2/3/3/3 | 1/1/1/2/2 |
| 15-3 | 1 | 2 | 1/2/3/3/3 | 1/1/1/2/2 |
| 15-4 | 1 | 2 | 1/2/3/3/3 | 1/1/1/2/2 |
| 15-5 | 1 | 1 | 1/2/2/3/3 | 1/1/1/2/2 |
| 15-6 | 1 | 1 | 1/2/2/3/3 | 1/1/1/2/2 |
| CE15-7 | 2 | 2 | 1/2/3/3/3 | 1/1/1/1/1 |
| 15-8 | 2 | 2 | 1/2/3/3/3 | 1/1/1/2/2 |
| 15-9 | 2 | 1 | 1/2/3/3/3 | 1/1/1/2/2 |
| CE15-10 | 2 | 2 | 1/2/3/3/3 | 1/1/1/2/2 |
| CE15-11 | 2 | 2 | 1/2/3/3/3 | 1/1/1/2/3 |
| CE15-12 | 1 | 2 | 1/1/1/3/3 | 1/1/1/1/1 |
| CE15-13 | 1 | 2 | 1/1/3/3/3 | 1/1/1/1/1 |
| CE15-14 | 1 | 2 | 1/1/3/3/3 | 1/1/1/1/1 |
| 15-15 | 1 | 2 | 1/1/3/3/3 | 1/1/1/1/1 |

Ranking/assessment:
1 = no change in lacquer surface
2 = slight damage to lacquer surface
3 = severe damage to lacquer surface

As is apparent from the results in table 5 the inventive coatings show good adhesion coupled with good resistances to hand cream and sun cream and to acetone and butyl acetate.

1.-14. (canceled)

15. A two-component system comprising the components A) and B), wherein
A) is at least one (meth)acrylate component based on (meth)acrylate monomers which is produced by reaction of the (meth)acryloyl units of at least the components A1) and A2), wherein
A1) is at least one alkyl ester of (meth)acrylic acid and
A2) is at least one hydroxyalkyl ester of (meth)acrylic acid which comprises a primary hydroxyl group and wherein the alkylene group of the hydroxyalkyl ester is linear and comprises 2 to 6 carbon atoms,
wherein the component A) comprises exclusively primary hydroxyl groups and has a hydroxyl number of 80 to 500 mg KOH/g and
B) is at least one polyisocyanate,
wherein the component A) additionally comprises the component C), wherein
C) is at least one dihydric or polyhydric alcohol and/or at least one polyaspartic ester, wherein
(a) the component A) is produced by reaction of the (meth)acryloyl units of at least the components A1), A2) and A3), wherein
A3) is at least one polysiloxane-containing (meth)acrylate
and/or
(b) the component A) additionally comprises the component D), wherein
D) is a polysiloxane which comprises at least one group reactive toward component B).

16. The two-component system according to claim 15, wherein the components A) and B) altogether contain not more than 3% by weight of a solvent based on the total weight of the two-component system.

17. Two-component system according to claim 15, wherein the component A) is produced by reaction of the (meth)acryloyl units of at least the components A1) and A2), wherein
A1) are at least two mutually distinct alkyl esters of (meth)acrylic acid and
A2) are at least two mutually distinct hydroxyalkyl esters of (meth)acrylic acid which each have a primary hydroxyl group and wherein the alkylene groups of the hydroxyalkyl esters are each linear and comprise 2 to 6 carbon atoms.

18. The two-component system according to claim 17, wherein the component A2) comprises at least two mutually distinct hydroxyalkyl esters and the alkylene group of one hydroxyalkyl ester comprises 2 or 3 carbon atoms and the alkylene group of the at least one other hydroxyalkyl ester comprises 4 or 5 carbon atoms.

19. The two-component system according to claim 15, wherein the at least one polysiloxane-containing (meth)acrylate A3) conforms to the formula (I) 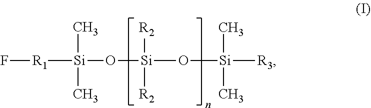
in which R₁ represents an alkylene group,
R₂ each independently of one another represent an alkyl or aryl group,
R₃ represents an alkyl group,
F represents an acryloxy or methacryloxy group and
n represents the average number of repeating units and is between 1 to 70.

20. The two-component system according to claim 15, wherein the polysiloxane of the component D) conforms to the formula (II) 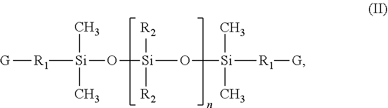
in which R₁ each independently of one another represent an alkylene group,
R₂ each independently of one another represent an alkyl or aryl group,
G each independently of one another represent an amino, mercapto, hydroxyl or hydroxypolyether group and
n represents the average number of repeating units and is between 1 to 50.

21. The two-component system according to claim 15, wherein the at least one polyisocyanate of the component B) is selected from the group consisting of aromatic, araliphatic, aliphatic and cycloaliphatic polyisocyanates which optionally comprise iminooxadiazinedione, isocyanurate, uretdione, urethane, allophanate, biuret, urea, oxadiazinetrione, oxazolidinone, acylurea and/or carbodiimide structures.

22. A composite part comprising a carrier and at least one coating in direct contact with the carrier,
wherein the carrier comprises a thermoplastic composition and
the coating is obtained by curing the two-component system according to claim 15.

23. The composite part according to claim 22, wherein the thermoplastic composition of the carrier comprises at least one polycarbonate.

24. A process for producing a composite part comprising a carrier and at least one coating comprising the steps of:
(i) providing a carrier, wherein the carrier comprises a thermoplastic composition,
(ii) applying at least the two-component system according to claim 15, wherein the two-component system is in direct contact with the carrier, and
(iii) curing the two-component system to afford a coating.

25. The process according to claim 24, comprising the process steps (i2) to (iv2), in which
(i2) in a first process step the melt of a thermoplastic composition is injected into a first mould cavity and subsequently cooled to afford a carrier,
(ii2) in a second process step the cavity of the injection moulding tool is enlarged to produce a gap,
(iii2) in a third process step the two-component system according to claim 15 is injected into the thus produced gap of step (ii2) between the carrier of the process step (i2) and the mould surface of the enlarged cavity, wherein the two-component system according to claim 15 is cured in direct contact with the surface of the carrier to form a composite part and
(iv2) in the fourth process step the composite part of step (iii2) is demoulded from the mould cavity,
wherein the process steps (i2) to (iv2) follow one another in immediate succession.

26. A method comprising utilizing the composite part according to claim 22 as an interior or exterior component of a rail, aerospace or motor vehicle, for electricals/electronics components and IT components.

27. A method comprising utilizing at least one polysiloxane-containing (meth)acrylate as comonomer A3) in a (meth)acrylate component A) based on (meth)acrylate monomers which is a component of a two-component system which comprises
A) at least the (meth)acrylate component based on (meth)acrylate monomers produced by reaction of the (meth)acryloyl units of at least the components A1), A2) and A3), wherein
A1) is at least one alkyl ester of (meth)acrylic acid,
A2) is at least one hydroxyalkyl ester of (meth)acrylic acid which comprises a primary hydroxyl group and wherein the alkylene group of the hydroxyalkyl ester is linear and comprises 2 to 6 carbon atoms and
A3) is at least one polysiloxane-containing (meth)acrylate,
wherein the component A) comprises exclusively primary hydroxyl groups and has a hydroxyl number of 80 to 500 mg KOH/g and
B) comprises at least one polyisocyanate,
wherein the component A) additionally comprises the component C), wherein
C) is at least one dihydric or polyhydric alcohol and/or at least one polyaspartic ester, for improving the adhesion properties of the two-component system.

28. A method comprising utilizing a polysiloxane which comprises at least one group reactive toward polyisocyanate components in a two-component system comprising
A) at least one (meth)acrylate component based on (meth)acrylate monomers produced by reaction of the (meth)acryloyl units of at least the components A1), A2) and optionally A3), wherein
A1) is at least one alkyl ester of (meth)acrylic acid,
A2) is at least one hydroxyalkyl ester of (meth)acrylic acid which comprises a primary hydroxyl group and wherein the alkylene group of the hydroxyalkyl ester is linear and comprises 2 to 6 carbon atoms and
A3) is optionally at least one polysiloxane-containing (meth)acrylate,
wherein the component A) comprises exclusively primary hydroxyl groups and has a hydroxyl number of 80 to 500 mg KOH/g and
B) at least one polyisocyanate,
wherein the component A) additionally comprises the component C), wherein
C) is at least one dihydric or polyhydric alcohol and/or at least one polyaspartic ester, for improving the adhesion properties of the two-component system.

29. The method comprising according to claim 27, wherein the adhesion properties of the two-component system with respect to a carrier comprising at least one polycarbonate are improved.
